(19) United States
(12) Patent Application Publication
(10) Pub. No.: US 2026/0339398 A1
(43) Pub. Date: Oct. 29, 2026

(54) Flexible Display Trim

(71) Applicant: Apple Inc., Cupertino, CA (US)

(72) Inventors: Alexandrine Obrand, Palo Alto, CA (US); Kevin Yeom, Santa Clara, CA (US); Jennifer L Jones, Santa Cruz, CA (US)

(21) Appl. No.: 19/558,921

(22) Filed: Mar. 6, 2026

Related U.S. Application Data
(60) Provisional application No. 63/796,852, filed on Apr. 29, 2025.
(60) Provisional application No. 63/917,027, filed on Nov. 13, 2025.

(51) Int. Cl. G06F 1/16; B29D 99/00

(52) U.S. Cl. CPC G06F 1/1656; B29D 99/0085; G06F 1/1641; G06F 1/1652

(57) ABSTRACT

An electronic device may include a foldable display that bends along a bend axis. A display trim may extend around a periphery of the display. The display trim may include a rigid polymer, an elastomeric polymer, and metal support structures. The rigid polymer may have a gap on each of the four sides of the display. The elastomeric polymer may span across each of the gaps and may allow the display trim to laterally expand during display assembly operations and to bend during folding. The rigid polymer may be overmolded onto the metal support structures. The metal support structures may include four L-shaped members that support respective corners of the display. In other arrangements, the display trim may be formed from one or more shots of adhesive that are molded directly to the display (e.g., to a display cover glass) and that span across the bend axis.

This application claims the benefit of U.S. provisional patent application No. 63/917,027, filed Nov. 13, 2025, and U.S. provisional patent application No. 63/796,852, filed Apr. 29, 2025, both of which are hereby incorporated by reference herein in their entireties.

### FIELD

This relates generally to electronic devices and, more particularly, to electronic devices with displays.

### BACKGROUND

Electronic devices often have displays. Portability may be a concern for some devices, which tends to limit available real estate for displays.

### SUMMARY

An electronic device may be provided with a foldable housing that allows the device to fold and unfold about a bend axis. A flexible display may be mounted in the foldable housing. The flexible display may have an array of pixels forming a display panel. The display panel may be configured to bend along the bend axis as the device is folded.

A display trim may extend around a periphery of the foldable display. The display trim may have a rigid polymer, an elastomeric polymer, and metal support structures. The rigid polymer may have first, second, third, and fourth gaps on respective first, second, third, and fourth sides of the display. The elastomeric polymer may span across each of the four gaps and may allow the display trim to laterally expand during assembly operations as the display is inserted into the display trim. The elastomeric polymer may also allow the display trim to bend along the bend axis as the device is folded and unfolded. The rigid polymer may be overmolded onto the metal support structures and may form a lip that hooks over a top surface of the display. The metal support structures may include four L-shaped members that support respective corners of the display. During opening and closing, the display may be configured to shear relative to the display trim, and the display trim may be configured to shear relative to a rear housing wall.

In some arrangements, the display trim may be formed from an adhesive that is molded directly to the display. The display may include a display panel with a pixel array and a cover glass overlapping the pixel array. The display may have first and second display portions that fold relative to one another along a bend axis. First and second support structures may respectively overlap the first and second display portions. The first and second support structures may be separated from one another by a gap that overlaps the bend axis. Each of the first and second support structures may have an upper surface that supports a peripheral edge of the cover glass. A compliant layer such as foam, double-sided adhesive, pressure-sensitive adhesive, elastic glue, or other compliant layer may be coupled between the support structure and the cover glass to form a compliant joint that allows the cover glass to shear relative to the other display layers.

During manufacturing, the display may be placed in a molding tool, and one or more shots of adhesive may be injected into the molding tool to form the display trim. The adhesive may be a low viscosity adhesive that flows throughout the mold at low pressure and low temperature to avoid damaging the display. A light source, heat source, or other energy source may be used to cure the adhesive. In some arrangements, an infrared light source may be used to accelerate curing by heating the adhesive without overly heating the display. Following curing, the molds may be peeled away from the display trim. The display trim may extend continuously around the entire perimeter of the cover glass, may extend across the bend axis, and may span across the gap between the first and second support structures. The support structures may include interlocking engagement features that form mechanical interlocks with the adhesive. If multiple shots of adhesives are used (e.g., a first shot to form the display trim in the bend region of the display and a second shot to form the display trim in the non-bending regions of the display), the different types of adhesive may be molded with interlocking engagement features to form mechanical interlocks with each other.

### BRIEF DESCRIPTION OF THE DRAWINGS

FIG. 1 is a schematic diagram of an illustrative electronic device in accordance with some embodiments.

FIG. 2 is a perspective view of an illustrative electronic device with a display surrounded by a display trim in accordance with some embodiments.

FIG. 3 is a side view of an illustrative electronic device in accordance with some embodiments.

FIG. 4 is a side view of an illustrative electronic device in a folded state in accordance with some embodiments.

FIG. 5 is a side view of an illustrative electronic device in an unfolded state in accordance with some embodiments.

FIG. 6 is a side view of an illustrative electronic device showing how a display trim may be configured in a non-bending region of a long edge in accordance with some embodiments.

FIG. 7 is a side view of an illustrative electronic device showing how a display trim may be configured in a bending region in accordance with some embodiments.

FIG. 8 is a side view of an illustrative electronic device showing how a display trim may be configured along outer segments of a short edge in accordance with some embodiments.

FIG. 9 is a side view of an illustrative electronic device showing how a display trim may be configured along center segments of a short edge in accordance with some embodiments.

FIG. 10 is an exploded perspective view of an illustrative electronic device having a display, a backing layer, and a display trim in accordance with some embodiments.

FIG. 11 is a side view of an illustrative electronic device showing how a display trim may be molded to a display in a non-bending region of a long edge in accordance with some embodiments.

FIG. 12 is a side view of an illustrative electronic device showing how a display trim may be molded to a display in a bend region of a long edge in accordance with some embodiments.

FIG. 13 is a side view of an illustrative electronic device showing how a display trim may be molded to a display in a non-bending region of a short edge in accordance with some embodiments.

FIG. 14 is a diagram of an illustrative molding tool being used to mold a display trim onto a display in accordance with some embodiments.

### DETAILED DESCRIPTION

Electronic devices may be provided with displays. Displays may be used for displaying images for users. Displays may be formed from arrays of light-emitting diode pixels or other pixels. For example, a device may have an organic light-emitting diode display or a display formed from an array of micro-light-emitting diodes (e.g., diodes formed from crystalline semiconductor dies).

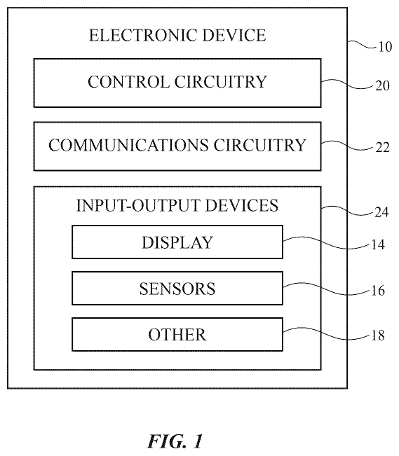

A schematic diagram of an illustrative electronic device having a display is shown in FIG. 1. Device 10 may be a cellular telephone, tablet computer, laptop computer, wristwatch device or other wearable device, a television, a stand-alone computer display or other monitor, a computer display with an embedded computer (e.g., a desktop computer), a system embedded in a vehicle, kiosk, or other embedded electronic device, a media player, or other electronic equipment. Configurations in which device 10 is a cellular telephone, tablet computer, or other portable electronic device may sometimes be described herein as an example. This is illustrative. Device 10 may, in general, be any suitable electronic device with a display.

Device 10 may include control circuitry 20. Control circuitry 20 may include storage and processing circuitry for supporting the operation of device 10. The storage and processing circuitry may include storage such as nonvolatile memory (e.g., flash memory or other electrically-programmable-read-only memory configured to form a solid state drive), volatile memory (e.g., static or dynamic random-access-memory), etc. Processing circuitry in control circuitry 20 may be used to gather input from sensors and other input devices and may be used to control output devices. The processing circuitry may be based on one or more microprocessors, microcontrollers, digital signal processors, baseband processors and other wireless communications circuits, power management units, audio chips, application specific integrated circuits, etc. During operation, control circuitry 20 may use a display and other output devices in providing a user with visual output and other output.

To support communications between device 10 and external equipment, control circuitry 20 may communicate using communications circuitry 22. Circuitry 22 may include antennas, radio-frequency transceiver circuitry (wireless transceiver circuitry), and other wireless communications circuitry and/or wired communications circuitry. Circuitry 22, which may sometimes be referred to as control circuitry and/or control and communications circuitry, may support bidirectional wireless communications between device 10 and external equipment over a wireless link (e.g., circuitry 22 may include radio-frequency transceiver circuitry such as wireless local area network transceiver circuitry configured to support communications over a wireless local area network link, near-field communications transceiver circuitry configured to support communications over a near-field communications link, cellular telephone transceiver circuitry configured to support communications over a cellular telephone link, or transceiver circuitry configured to support communications over any other suitable wired or wireless communications link). Wireless communications may, for example, be supported over a Bluetooth® link, a WiFi® link, a wireless link operating at a frequency between 6 GHz and 300 GHz, a 60 GHz link, or other millimeter wave link, cellular telephone link, wireless local area network link, personal area network communications link, or other wireless communications link. Device 10 may, if desired, include power circuits for transmitting and/or receiving wired and/or wireless power and may include batteries or other energy storage devices. For example, device 10 may include a coil and rectifier to receive wireless power that is provided to circuitry in device 10.

Device 10 may include input-output devices such as devices 24. Input-output devices 24 may be used in gathering user input, in gathering information on the environment surrounding the user, and/or in providing a user with output. Devices 24 may include one or more displays such as display 14. Display 14 may be an organic light-emitting diode display, a liquid crystal display, an electrophoretic display, an electrowetting display, a plasma display, a microelectromechanical systems display, a display having a pixel array formed from crystalline semiconductor light-emitting diode dies (sometimes referred to as microLEDs), and/or other display. Configurations in which display 14 is an organic light-emitting diode display or microLED display are sometimes described herein as an example.

Display 14 may have an array of pixels configured to display images for a user. The pixels may be formed as part of a display panel that is bendable. This allows device 10 to be folded and unfolded about a bend axis. For example, a flexible (bendable) display in device 10 may be folded so that device 10 may be placed in a compact shape for storage and may be unfolded when it is desired to view images on the display.

Sensors 16 in input-output devices 24 may include force sensors (e.g., strain gauges, capacitive force sensors, resistive force sensors, etc.), audio sensors such as microphones, touch and/or proximity sensors such as capacitive sensors (e.g., a two-dimensional capacitive touch sensor integrated into display 14, a two-dimensional capacitive touch sensor overlapping display 14, and/or a touch sensor that forms a button, trackpad, or other input device not associated with a display), and other sensors. If desired, sensors 16 may include optical sensors such as optical sensors that emit and detect light, ultrasonic sensors, optical touch sensors, optical proximity sensors, and/or other touch sensors and/or proximity sensors, monochromatic and color ambient light sensors, image sensors, fingerprint sensors, temperature sensors, sensors for measuring three-dimensional non-contact gestures (“air gestures”), pressure sensors, sensors for detecting position, orientation, and/or motion (e.g., accelerometers, magnetic sensors such as compass sensors, gyroscopes, and/or inertial measurement units that contain some or all of these sensors), health sensors, radio-frequency sensors, depth sensors (e.g., structured light sensors and/or depth sensors based on stereo imaging devices that capture three-dimensional images), optical sensors such as self-mixing sensors and light detection and ranging (lidar) sensors that gather time-of-flight measurements, humidity sensors, moisture sensors, gaze tracking sensors, and/or other sensors. In some arrangements, device 10 may use sensors 16 and/or other input-output devices to gather user input. For example, buttons may be used to gather button press input, touch sensors overlapping displays can be used for gathering user touch screen input, touch pads may be used in gathering touch input, microphones may be used for gathering audio input, accelerometers may be used in monitoring when a finger contacts an input surface and may therefore be used to gather finger press input, etc.

If desired, electronic device 10 may include additional components (see, e.g., other devices 18 in input-output devices 24). The additional components may include haptic output devices, audio output devices such as speakers, light-emitting diodes for status indicators, light sources such as light-emitting diodes that illuminate portions of a housing and/or display structure, other optical output devices, and/or other circuitry for gathering input and/or providing output. Device 10 may also include a battery or other energy storage device, connector ports for supporting wired communication with ancillary equipment and for receiving wired power, and other circuitry.

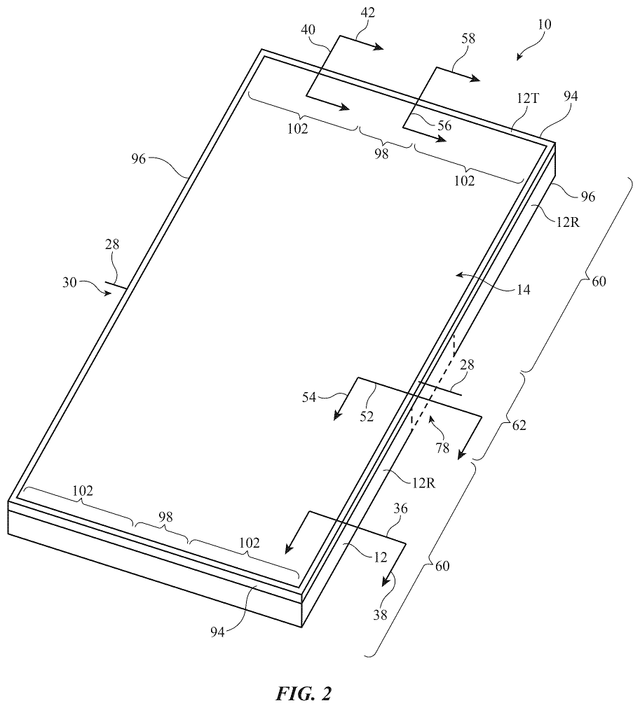

FIG. 2 is a perspective view of electronic device 10 in an illustrative configuration in which device 10 is a portable electronic device such as a cellular telephone or tablet computer. As shown in FIG. 2, device 10 may have a display such as display 14. Display 14 may cover some or all of the front face of device 10. Touch sensor circuitry such as two-dimensional capacitive touch sensor circuitry may be incorporated into display 14.

Display 14 may be mounted in housing 12. Housing 12 may form front and rear housing walls, sidewall structures, and/or internal supporting structures (e.g., a frame, an optional midplate member, etc.) for device 10. Glass structures, transparent polymer structures, and/or other transparent structures that cover display 14 and other portions of device 10 may provide structural support for device 10 and may sometimes be referred to as housing structures. For example, a transparent housing portion such as a glass or polymer housing structure that covers and protects a pixel array in display 14 may serve as a display cover layer for the pixel array while also serving as a housing wall on the front face of device 10. In configurations in which a display cover layer is formed from glass, the display cover layer may sometimes be referred to as a display cover glass or display cover glass layer. The portions of housing 12 on the sidewalls and rear wall of device 10 may be formed from glass or other transparent structures and/or opaque structures. Sidewalls and rear wall structures may be formed as extensions to the front portion of housing 12 (e.g., as integral portions of the display cover layer) and/or may include separate housing wall structures.

Device 10 may be a foldable electronic device that folds along one or more bend axes such as bend axis 28. In the example of FIG. 2, device 10 includes first and second portions 60 joined by bendable portion 62. Portions 60 of device 10 (e.g., portions 60 of display 14 and housing 12, sometimes referred to as the non-bending regions of device 10, display 14, and/or housing 12) may rotate relative to one another about axis 28. As one portion 60 rotates relative to another portion 60 (e.g., during folding and unfolding of device 10), bendable portion 62 of display 14 may bend and flex (e.g., while portions 60 remain flat).

Housing 12 may have flexible structures (e.g., bendable housing wall structures) and/or hinge structures such as hinge 30. Hinge 30 may have a hinge axis aligned with device bend axis 28. Hinge 30 and/or flexible housing structures that overlap bend axis 28 may allow housing 12 to bend about bend axis 28. For example, portion 60 of housing 12 may be located on one side of bend axis 28 and another portion 60 of housing 12 may be located on the opposing side of bend axis 28. Portions 60 of housing 12 may be coupled by hinge 30 for rotational motion about axis 28.

As housing 12 is bent about bend axis 28, the flexibility of display 14 allows display 14 to also bend about axis 28. In an illustrative configuration, housing 12 and display 14 may bend by 180°. This allows display 14 to be folded back on itself (with first and second outwardly facing portions of display 14 facing each other). The ability to place device 10 in a folded configuration in this way may help make device 10 compact so that device 10 can be stored efficiently. When it is desired to view images on display 14, device 10 may be unfolded about axis 28 to place device 10 in the unfolded configuration of FIG. 2. This allows display 14 to lie flat and allows a user to view flat images on display 14. The ability to fold display 14 onto itself allows device 10 to exhibit an inwardly folding behavior. Display 14 may be sufficiently flexible to allow device 10 to be folded outwardly and/or inwardly.

Device 10 of FIG. 2 has a rectangular outline (rectangular periphery) with four corners. As shown in FIG. 2, a first pair of parallel edges such as edges 96 (sometimes referred to as long edges 96) may be longer than a second pair of parallel edges such as edges 94 (sometimes referred to as short edges 94). Edges 96 may be oriented at right angles to edges 94. In this type of configuration, housing 12 is elongated along a longitudinal axis that is perpendicular to bend axis 28. Housing 12 may have other shapes, if desired (e.g., shapes in which housing 12 has a longitudinal axis that extends parallel to bend axis 28). With an arrangement of the type shown in FIG. 2, the length of device 10 along its longitudinal axis may be reduced by folding device 10 about axis 28.

Housing 12 may include rear housing wall 12R and display trim 12T. Rear housing wall 12R may form a rear face of device 10. If desired, rear housing wall 12R may extend continuously across bendable region 62 of device 10, or rear housing wall 12R may have a gap in region 62 such as gap 78 that overlaps and extends parallel to bend axis 28.

Display trim 12T may extend partially or entirely around the periphery of display 14. In some arrangements, display trim 12T may be used to attach display 14 to other portions of housing 12 such as rear housing wall 12R. In other arrangements, display trim 12T may be attached to display 14 but may not be directly attached to other portions of housing 12 such as rear housing wall 12R. For example, in arrangements where display 14 is configured to shear relative to rear housing wall 12R as device 10 is opened and closed, trim 12T may be coupled to display 14 but may not be directly coupled to rear housing wall 12R so that trim 12T and display 14 can move relative to housing 12 as device 10 is folded.

If desired, display trim 12T may form a continuous, rectangular loop without breaks around display 14. To accommodate bending in region 62 while providing sufficient display protection, display trim 12T may be formed from one or more different types of materials. For example, in an illustrative configuration, display trim 12T may include one or more different types of polymers, one or more different types of adhesives, and/or one or more metal support structures. A first type of polymer or adhesive (e.g., a rigid polymer such as polycarbonate or other stiff polymer) may be used in non-bending regions 60 (e.g., at the four corners of display 14 and along other non-bending regions of display 14), whereas a second type of polymer or adhesive (e.g., a flexible polymer such as silicone or other elastomeric material) may be used in bend region 62. If desired, some or all of trim 12T may include both the first and second types of polymers, or each segment of trim 12T may only include one of the two types of polymers.

In some arrangements, the second type of polymer (e.g., silicone or other elastomeric material) may be used along certain non-bending segments of trim 12T in non-bending regions 60 to allow trim 12T to expand laterally outward to receive and accommodate display 14 during assembly operations. For example, elastomeric polymer may be used in center segments 98 of short edges 94 of trim 12T, whereas a rigid polymer may be used in outer segments 102 of short edges 94 of trim 12T. With this type of arrangement, the elastomeric polymer may bridge across gaps in the rigid polymer (e.g., gaps located in segments 98 of short edges 94 and gaps located in bend region 62 of long edges 96). This may allow trim 12T to expand laterally outward as display 14 is mounted in trim 12T during assembly operations. Due to the elastic properties of the elastomeric polymer in trim 12T, trim 12T may return back to its original dimensions after display 14 is inserted into trim 12T. Following insertion, trim 12T may hook over top and bottom surfaces of display 14, if desired.

Trim 12T may also include metal support structures (sometimes referred to as end caps). The metal support structures of trim 12T may be configured to support non-bending regions 60 of display 14 (e.g., the four corners and other non-bending regions of display 14). To allow display 14 to bend and flex in bend region 62, the metal support structures may be absent from bend region 62. The metal support structures may, for example, include a pair of L-shaped metal support structures in each of the two non-bending regions 60 of trim 12T. The two L-shaped metal support structures may be decoupled from one another at center segment 98 of each short side 94 to allow trim 12T to expand laterally outward to receive and accommodate display 14 during assembly operations. The polymer materials of trim 12T may be overmolded onto the metal support structures, if desired. The polymer materials of trim 12T may provide a uniform appearance on the exterior of trim 12T, such that trim 12T appears to be formed from a single structure that extends continuously around the entire periphery of display 14. The use of metal support structures is merely illustrative. If desired, the support structures (e.g., the end caps) of trim 12T may be formed from rigid polymer or other suitable materials.

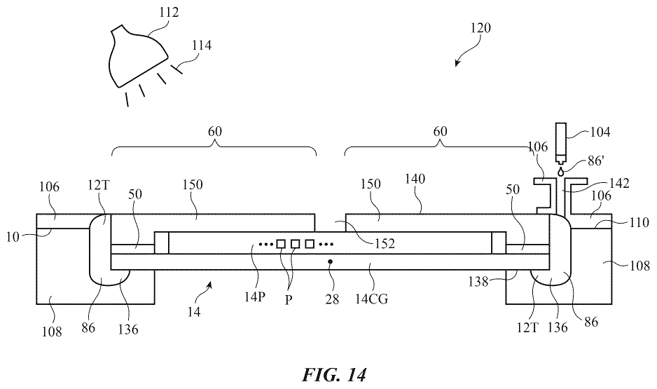

In some arrangements, trim 12T may be assembled onto display 14 after trim 12T is formed. In other arrangements, trim 12T may be molded directly onto display 14. For example, display 14 may be placed in a molding tool (e.g., molding tool 120 of FIG. 14 including two or more molds, three or more nesting molds, etc.) and a liquid adhesive (e.g., a two-component polyurethane adhesive, a one-component light cured acrylic, or other suitable adhesive) may be dispensed into the molding tool. To ensure that display 14 is not damaged during the molding process, the adhesive that forms trim 12T may be a low viscosity adhesive that is able to flow through the mold at low pressure (e.g., at room temperature in a vacuum environment). When the adhesive has flowed throughout the molding tool to surround the periphery of display 14, heat and/or light may be applied to cure the adhesive. For example, heat may be applied to accelerate curing of a two-component polyurethane adhesive, or light may be applied to cure a one-component acrylic adhesive. If desired, heat may be applied by an infrared light source without placing the entire mold and display into an oven. Infrared light may be configured to heat the adhesive relatively quickly without excessively heating the display. For example, the heat that is applied to cure the adhesive in the molding tool may remain below 65 degrees Celsius to avoid damaging the display in the molding tool, if desired. The adhesive that forms trim 12T may form an outermost exposed surface of device 10 and may be configured to withstand repeated handling and contact by a user.

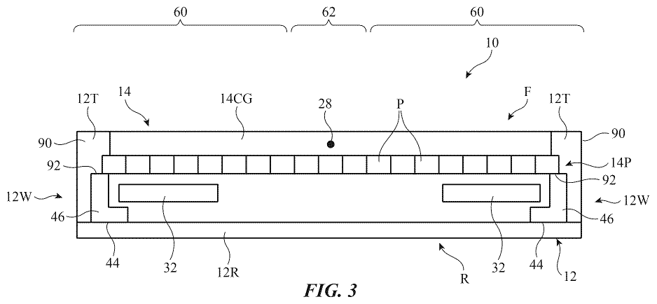

FIG. 3 is a cross-sectional side view of an illustrative foldable electronic device. Device 10 of FIG. 3 may bend about bend axis 28. Bend axis 28 may be aligned with display cover layer 14CG or other structures in device 10. For example, bend axis 28 may pass through a portion of display cover layer 14CG or may be located above or below layer 14CG.

As shown in FIG. 3, display 14 includes an array of pixels P forming display panel 14P under an inwardly facing surface of display cover layer 14CG. Display panel 14P may be, for example, a flexible organic light-emitting diode display or a microLED display in which light-emitting pixels are formed on a flexible substrate layer (e.g., a flexible layer of polyimide or a sheet of other flexible polymer). Flexible support layer(s) for display 14 may also be formed from flexible glass, flexible metal, and/or other flexible structures.

Display cover layer 14CG may be formed from polymer, glass, crystalline materials such as sapphire, other materials, and/or combinations of these materials. To enhance flexibility, a portion of layer 14CG that overlaps bend axis 28 may be locally thinned (e.g., this portion may be thinned relative to portions of layer 14CG that do not overlap bend axis 28). The thickness of layer 14CG (e.g., the non-thinned portions of layer 14CG) may be 50-200 microns, 70-150 microns, 100-200 microns, 100-600 microns, at least 100 microns, at least 200 microns, less than 600 microns, less than 400 microns, less than 250 microns, less than 150 microns, less than 100 microns, at least 50 microns, or other suitable thickness.

In the example of FIG. 3, housing 12 has a portion 12R on rear face R that forms a rear housing wall, has side portions forming sidewalls 12W, and has trim portions forming display trim 12T (e.g., a frame around display 14). If desired, some or all of rear housing wall 12R, sidewalls 12W, and display trim 12T may be formed from the same material and/or a unitary structure. For example, display trim 12T may also from sidewalls 12W, if desired. The rear housing wall 12R of housing 12 may form a support layer for components in device 10. Housing 12 may also have one or more interior supporting layers (e.g., frame structures such as an optional midplate, etc.). These interior supporting layers and the rear housing wall may have first and second portions that are coupled to opposing sides of a hinge that is aligned with bend axis 28 (see, e.g., hinge 30 of FIG. 2) or may be sufficiently flexible to bend around bend axis 28.

Electrical components 32 may be mounted in the interior of device 10 (e.g., between display 14 and the rear of housing 12). Components 32 may include circuitry of the type shown in FIG. 1 (e.g., control circuitry 20, communications circuitry 22, input-output devices 24, batteries, etc.). Display 14 may be mounted on front face F of device 10. When device 10 is folded about axis 28, display cover layer 14CG, display panel 14P, and the other structures of device 10 that overlap bend axis 28 may flex and bend to accommodate folding.

Trim 12T may extend partially or completely around the periphery of device 10. As shown in FIG. 3, trim 12T may include polymer portion 90 and metal portion 46. Polymer portion 90 may be overmolded onto metal portion 46. Metal portion 46 may form metal support structures in non-bending regions 60 of trim 12T. Metal portion 46 of trim 12T may have an upper surface 92 that supports display panel 14P. If desired, one or more compliant layers (e.g., foam layers, adhesive layers, etc.) may be interposed between upper surface 92 and display panel 14P to provide additional support for display 14. Metal portion 46 of trim 12T may have an opposing lower surface 44 that slides relative to rear housing wall 12R. In particular, as device 10 opens and closes, display 14 and trim 12T may slide relative to rear housing wall 12R to accommodate bending of display 14. The use of metal to form portion 46 is merely illustrative. If desired, portion 46 of trim 12T may be formed from polymer (e.g., a rigid polymer) or any other suitable rigid material. Arrangements in which portion 46 is formed from metal are sometimes described herein as an illustrative example.

As discussed above in connection with FIG. 2, trim 12T may have a different construction in non-bending regions 60 of display 14 than in bending region 62 of display 14. In particular, polymer portion 90 of trim 12T may be formed from a rigid polymer in non-bending regions 60 and may be formed from a flexible polymer such as an elastomeric polymer in bending region 62. Metal portion 46 may be absent from bending region 62 of trim 12T.

If desired, certain segments of trim 12T may include breaks (e.g., gaps, joints, etc.) in the rigid polymer and metal support structures to allow trim 12T expand laterally outward during assembly operations when display 14 is being mounted in trim 12T. An elastomeric polymer such as silicone or other elastomer may span gaps in the rigid polymer in non-bending regions 60 to allow for this type of lateral expansion during assembly operations.

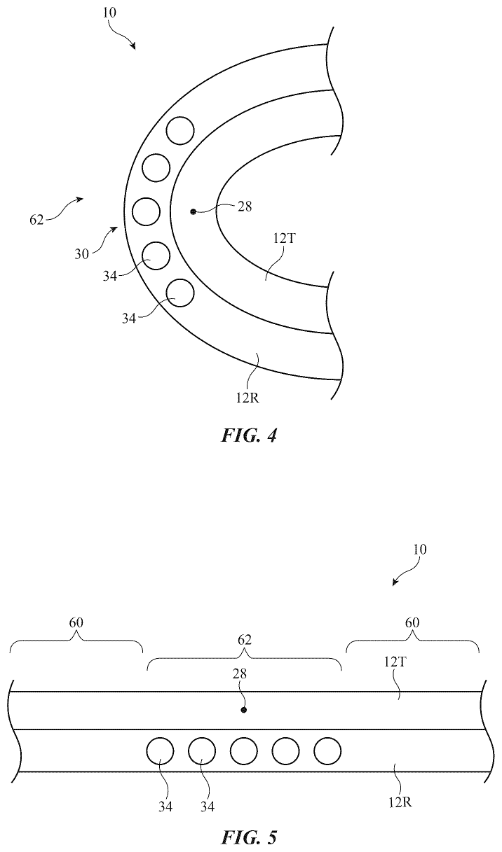

FIGS. 4 and 5 show side views of device 10 in respective folded and open states. As shown in FIG. 4, trim 12T may span across bending region 62 and may be overlapped by hinge 30 in bend region 62. Hinge 30 may be a roller hinge having one or more rollers such as cylindrical rollers 34. Rollers 34 may extend parallel to bend axis 28.

As device 10 moves from the folded (e.g., closed) state of FIG. 4 to the unfolded (e.g., open) state of FIG. 5, trim 12T (and display 14, which is surrounded by trim 12T) may slide relative to rear housing wall 12R. In particular, the outer edges of display 14 and trim 12T (e.g., short edges 94 of FIG. 2) may move inward towards hinge 30 as device 10 moves from the folded state of FIG. 4 to the unfolded state of FIG. 5. When device 10 moves from the unfolded state of FIG. 5 to the folded state of FIG. 4, short edges 94 of display 14 and trim 12T may move outward away from hinge 30. Metal housing portion 46 of trim 12T may slide relative to rear housing 12R to accommodate this motion of trim 12T and display 14 relative to rear housing wall 12R.

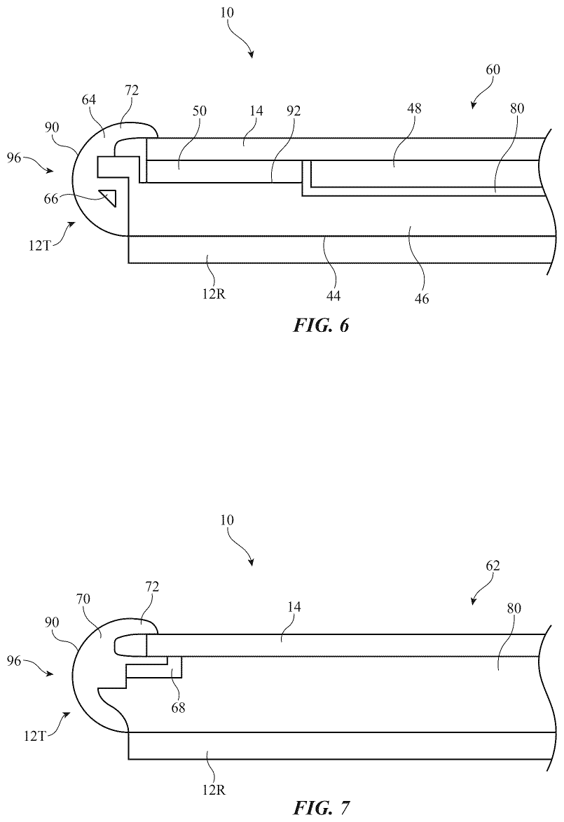

FIG. 6 is a side view of device 10 showing how display trim 12T may be configured along long edges 96 in non-bending regions 60. The side view of FIG. 6 is taken along line 36 and viewed in direction 38 of FIG. 2. In non-bending regions 60, display 14 may be supported by a backing member such as backing member 48. Backing member 48 (sometimes referred to as a backplate or metal backplate) may be formed from metal, polymer, glass, and/or other suitable materials. Display 14 and backing member 48 may be received within a rectangular opening of trim 12T such as opening 80.

In non-bending regions 60, trim 12T may include polymer portion 90 and metal portion 46. Polymer portion 90 in region 60 may include polymer material 64. As trim 12T does not need to bend in region 60, polymer material 64 may be a rigid polymer such as polycarbonate or other suitable rigid polymer (e.g., a polymer having a higher elastic modulus than silicone). Polymer material 64 may be overmolded onto metal portion 46 (e.g., metal support structure 46). If desired, metal support structure 46 may have interlocking engagement structures such as interlock structure 66 that helps ensure proper mechanical engagement between polymer material 64 and metal support structure 46. Polymer material 64 may have a lip portion such as lip portion 72 that hooks over the top of display 14. Metal support structure 46 may include upper surface 92 that supports display 14. A compliant layer such as compliant layer 50 (e.g., a layer of foam, double-sided adhesive, pressure-sensitive adhesive, elastic glue, or other compliant layer) may be interposed between display 14 and upper surface 92 of metal support structure 46. If desired, the edge of display 14 and compliant layer 50 may be sandwiched between lip portion 72 and surface 92 of trim 12T. Lower surface 44 of trim 12T may be configured to slide (e.g., shear) relative to rear housing wall 12R during opening and closing of device 10.

FIG. 7 is a side view of device 10 showing how display trim 12T may be configured along long edges 96 in bending regions 62. The side view of FIG. 7 is taken along line 52 and viewed in direction 54 of FIG. 2. In bending regions 62, backing member 48 may be absent to provide display 14 with additional flexibility in region 62.

In bending regions 62, trim 12T may include polymer portion 90. Polymer portion 90 in region 62 may include polymer material 70. As trim 12T needs to bend and flex in region 62, polymer material 70 may have a lower modulus of elasticity than polymer material 64. For example, polymer material 70 may be a flexible polymer such as silicone or other elastomeric polymer. Metal portion 46 may be absent from trim 12T in bending region 62. If desired, rigid polymer material 64 may also be absent from bending region 62. Polymer material 70 may have a lip portion such as lip portion 72 that hooks over the top of display 14. A soft glue (e.g., an elastic adhesive) such as adhesive 68 may adhere polymer material 70 to the underside of display 14. If desired, the edge of display 14 may be sandwiched between lip portion 72 and adhesive 68.

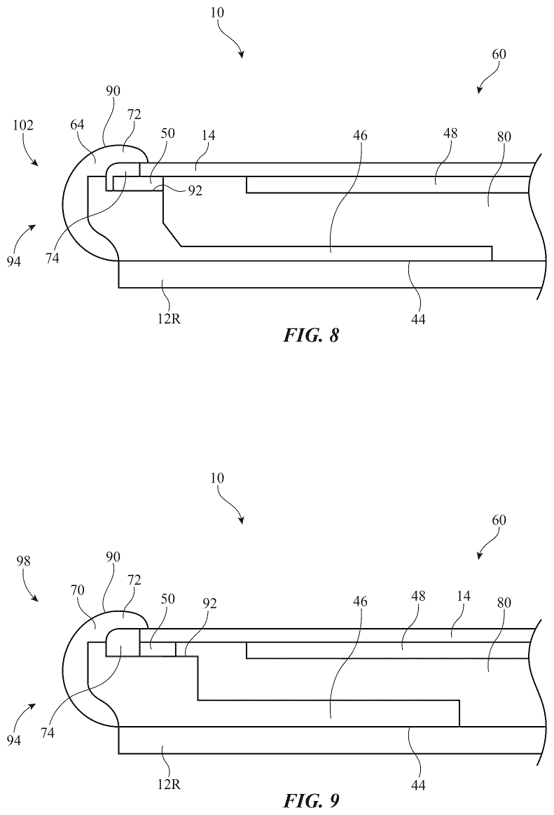

FIG. 8 is a side view of device 10 showing how display trim 12T may be configured along outer segments 102 (FIG. 2) of short edges 94 in non-bending regions 60. The side view of FIG. 8 is taken along line 40 and viewed in direction 42 of FIG. 2.

In non-bending regions 60, display 14 may be supported by backing member 48, and trim 12T may include polymer portion 90 and metal portion 46. Polymer portion 90 in region 60 may include polymer material 64 (e.g., the same material that forms polymer portion 90 along long edges 96 in non-bending regions 60, or other suitable rigid polymer). As trim 12T does not need to bend in region 60, polymer material 64 may be a rigid polymer such as polycarbonate or other suitable rigid polymer. Polymer material 64 may be overmolded onto metal support structure 46. Polymer material 64 may have a lip portion such as lip portion 72 that hooks over the top of display 14. Metal support structure 46 may include upper surface 92 that supports display 14. A compliant layer such as compliant layer 50 (e.g., a layer of foam, elastomer, double-sided adhesive, pressure-sensitive adhesive, elastic glue, or other compliant layer) may be interposed between display 14 and upper surface 92 of metal support structure 46. If desired, the edge of display 14 and compliant layer 50 may be sandwiched between lip portion 72 and surface 92 of trim 12T. An air gap such as air gap 74 may be formed between lip portion 72 and compliant layer 50 to allow display 14 to shear relative to trim 12T within air gap 74 during opening and closing of device 10. Lower surface 44 of trim 12T may also be configured to slide (e.g., shear) relative to rear housing wall 12R during opening and closing of device 10.

FIG. 9 is a side view of device 10 showing how display trim 12T may be configured along center segments 98 (FIG. 2) of short edges 94 in non-bending regions 60. The side view of FIG. 9 is taken along line 56 and viewed in direction 58 of FIG. 2.

In non-bending regions 60, display 14 may be supported by backing member 48, and 12T may include polymer portion 90 and metal portion 46. Although polymer portion 90 does not need to bend in this region, it may be desirable to use a flexible (e.g., elastomeric) polymer instead of a rigid polymer along segments 98 of short edges 94 of trim 12T to allow for lateral expansion of trim 12T during assembly operations. In particular, center segment 98 of each short edge 94 of trim 12T may include a gap in rigid polymer material 64 that is spanned by elastomeric polymer material 70. This allows trim 12T to expand laterally outward as display 14 is mounted into opening 80 of trim 12T. Metal support structures 46 may also have a break (e.g., a joint or cut away portion) along center segment 98 of each short edge 94 of trim 12T to allow for this type of lateral expansion.

Polymer material 70 may be overmolded onto metal support structure 46. Polymer material 70 may have a lip portion such as lip portion 72 that hooks over the top of display 14. Metal support structure 46 may include upper surface 92 that supports display 14. A compliant layer such as compliant layer 50 (e.g., a layer of foam, elastomer, double-sided adhesive, pressure-sensitive adhesive, elastic glue, or other compliant layer) may be interposed between display 14 and upper surface 92 of metal support structure 46. If desired, the edge of display 14 and compliant layer 50 may be sandwiched between lip portion 72 and surface 92 of trim 12T. An air gap such as air gap 74 may be formed between lip portion 72 and compliant layer 50 to allow display 14 to shear relative to trim 12 within air gap 74 during opening and closing of device 10. Lower surface 44 of trim 12T may also be configured to slide (e.g., shear) relative to rear housing wall 12R during opening and closing of device 10

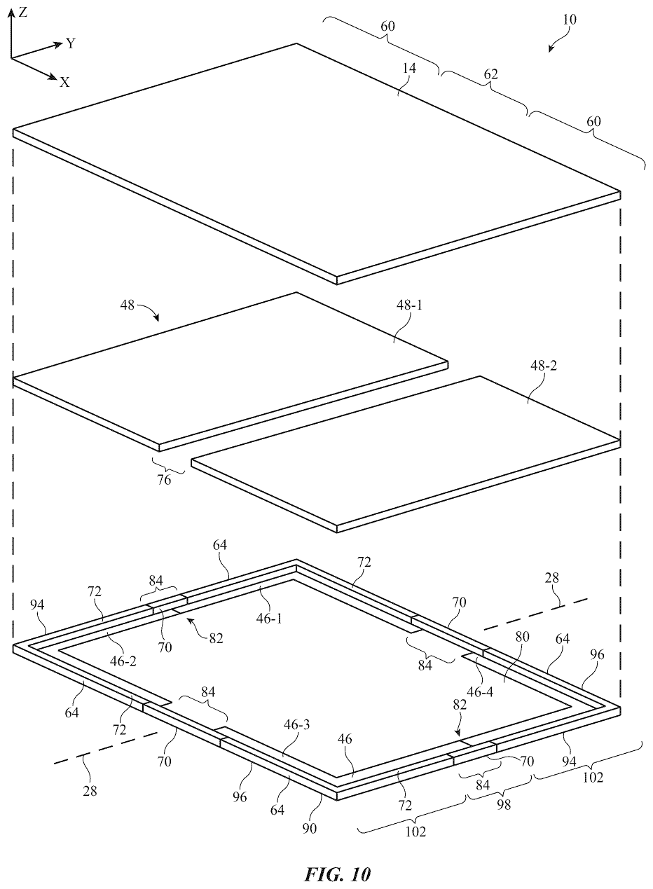

An exploded perspective view of device 10 including display trim 12T of FIGS. 2-9 is shown in FIG. 10. As shown in FIG. 10, trim 12T may form a continuous loop around a rectangular opening such as opening 80. Display 14 and backing layer 48 may be received within opening 80. Backing layer 48 may include backplate 48-1 and backplate 48-2 in non-bending regions 60 separated by gap 76 in bending region 62. Backplate 48-1 may support a first portion of display 14 on a first side of hinge 30 and backplate 48-2 may support a second portion of display 14 on a second opposing side of hinge 30.

Trim 12T may include polymer portion 90 overmolded onto metal portion 46. Metal portion 46 may include one or more metal support structures such as metal support structures 46-1, 46-2, 46-3, and 46-4. If desired, metal support structures 46-1, 46-2, 46-3, and 46-4 may each have an L-shape that supports a respective one of the four corners of display 14. Metal support structures 46-1 and 46-2 may be located in non-bending region 60 on a first side of axis 28, and metal support structures 46-3 and 46-4 may be located in non-bending region 60 on an opposing second side of axis 28. To allow trim 12T to bend along axis 28, metal portion 46 may be absent from bending region 62. As shown in FIG. 10, for example, metal support structures 46-2 and 46-3 may be separated by a first gap 84 in bending region 62 (e.g., on a first side of display 14), and metal support structures 46-1 and 46-4 may be separated by a second gap 84 in bending region 62 (e.g., on a second opposing side of display 14).

Polymer portion 90 of trim 12T may include elastomeric polymer 70 in bending region 62 and rigid polymer material 64 in non-bending regions 60. Elastomeric polymer material 70 may span across each gap 84 in bending region 62 of trim 12T. As display 14 is not supported by metal support structures 46 in this gap, a soft adhesive layer such as adhesive 68 of FIG. 6 may attach the underside of display 14 to elastomeric polymer 70.

Metal support structures 46 may extend laterally into opening 80 and may form a shelf that helps support the peripheral edges of display 14 (see, e.g., surface 92 and compliant layer 50 of FIGS. 6, 8, and 9). Display 14 may be received within opening 80 of trim 12T, and the outer edges of display 14 may be sandwiched between lip 72 of polymer portion 90 and upper surface 92 of metal support structures 46. As the lateral dimensions of display 14 may be larger than the opening defined by lip 72, trim 12T may be configured to expand laterally outward in dimensions X and Y of FIG. 10 to accommodate insertion of display 14 and backing layer 48 into opening 80.

To accommodate this type of expansion, trim 12T may include breaks and/or gaps in the rigid materials along short edges 94 of trim 12T. In particular, center segments 98 of trim 12T may include gap 84 in rigid polymer material 64 that is spanned by elastomeric polymer material 70. Center segments 98 of trim 12T may also include a break such as break 82 in metal portion 46 that allows metal support structure 46-1 to move away from metal support structure 46-2 and that allows metal support structure 46-3 to move away from metal support structure 46-4 as trim 12T is expanded during assembly operations.

When display 14 and backplate 48 are mounted into trim 12T, trim 12T may expand laterally outward in the X and Y directions of FIG. 10 as display 14 is inserted in the Z direction into opening 80. Elastomeric polymer 70 may stretch and expand, metal support structure 46-1 may move away from metal support structure 46-2, and metal support structure 46-3 may move away from metal support structure 46-4 to accommodate insertion of display 14 and backing layer 48. Once display 14 and backing layer 48 are inserted, trim 12T may contract to its original size and the outer peripheral edges of display 14 may be sandwiched between metal support structures 46 and lip 72 of polymer portion 90. An air gap such as air gap 74 (FIGS. 8 and 9) may provide space for display 14 to slide and shear within trim 12 during opening and closing of device 10. The lower surface of metal support structures 46 (e.g., lower surface 44 of FIGS. 3, 6, 8, and 9) may also slide and shear relative to rear housing wall 12R during opening and closing of device 10. The foregoing examples in which support structures 46 are metal support structures are merely illustrative. If desired, support structures 46 of trim 12T (e.g., trim 12T of any of the previously described figures) may be formed from a rigid polymer or any other suitable material.

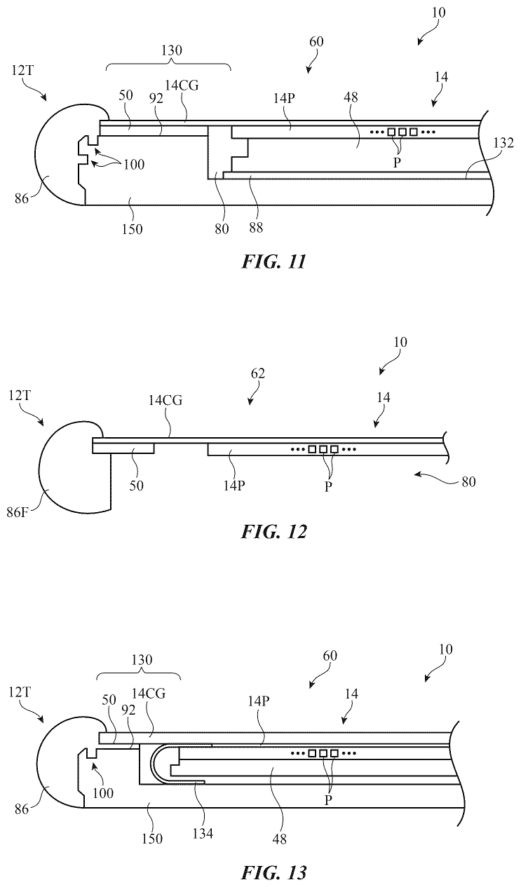

FIGS. 11-13 show side views of device 10 of FIG. 2 in an alternative arrangement in which display trim 12T is molded directly onto display 14. Unlike the embodiments of FIGS. 6-9 in which display trim 12T is formed separately and subsequently assembled onto display 14, display trim 12T of FIGS. 11-13 is molded directly onto display 14 using a molding tool such as molding tool 120 of FIG. 14.

FIG. 11 is a side view of device 10 showing how display trim 12T may be configured along long edges 96 in non-bending regions 60. The side view of FIG. 11 is taken along line 36 and viewed in direction 38 of FIG. 2.

Display 14 may include display panel 14P and display cover layer 14CG. Display panel 14P includes an array of pixels P that displays images through cover layer 14CG. Display panel 14P may be, for example, a flexible organic light-emitting diode display or a microLED display in which light-emitting pixels are formed on a flexible substrate layer (e.g., a flexible layer of polyimide or a sheet of other flexible polymer). Flexible support layer(s) for display 14 may also be formed from flexible glass, flexible metal, and/or other flexible structures.

Display cover layer 14CG may be formed from polymer, glass, crystalline materials such as sapphire, other materials, and/or combinations of these materials. Arrangements in which display cover layer 14CG is formed from glass are sometimes described herein as an example. To enhance flexibility, a portion of cover layer 14CG (sometimes referred to as a cover glass) that overlaps bend axis 28 may be locally thinned (e.g., this portion may be thinned relative to portions of layer 14CG that do not overlap bend axis 28). The thickness of layer 14CG (e.g., the non-thinned portions of layer 14CG) may be 50-200 microns, 70-150 microns, 100-200 microns, 100-600 microns, at least 100 microns, at least 200 microns, less than 600 microns, less than 400 microns, less than 250 microns, less than 150 microns, less than 100 microns, at least 50 microns, or other suitable thickness. This is merely illustrative. If desired, cover glass 14CG may have a uniform thickness across non-bending regions 60 and bend region 62.

In non-bending regions 60, display 14 may be supported by a backing member such as backing member 48. Backing member 48 (sometimes referred to as a backplate or metal backplate) may be formed from metal, polymer, glass, and/or other suitable materials. Display 14 and backing member 48 may be received within a rectangular opening of trim 12T such as opening 80.

In non-bending regions 60, display 14 may be supported by one or more support structures such as support structure 150. A first support structure 150 may overlap a first non-bending region 60 of display 14, and a second support structure 150 may overlap a second non-bending region 60 of display 14. The first and second support structures 150 may be separated from each other by a gap in bend region 62 that overlaps bend axis 28. Support structure 150 may be formed from metal, polymer, glass, ceramic, and/or any other suitable materials or combinations of these materials. Support structure 150 may include surface 132 that supports display panel 14P. As shown in FIG. 11, an optional layer of adhesive such as adhesive 88 may be used to attach backplate 48 of display 14 to upper surface 132 of support structure 150. If desired, adhesive 88 may permit backplate 48 to shear relative to support structure 150 during opening and closing of device 10.

Support structure 150 may include upper surface 92 that supports peripheral edges 130 of display cover glass 14CG. Edges 130 of cover glass 14CG may extend beyond the edges of display panel 14P (e.g., edges 130 may be nonoverlapping with display panel 14P). A compliant layer such as compliant layer 50 (e.g., foam, elastomeric polymer, double-sided adhesive, pressure-sensitive adhesive, elastic glue, or other compliant layer) may be interposed between edges 130 of cover glass 14CG and upper surface 92 of support structure 150. Compliant layer 50 may provide a seal around display panel 14P and may support cover glass 14CG while allowing shear displacement between cover glass 14CG and display panel 14P.

Trim 12T may be formed from adhesive such as adhesive 86 that is molded directly onto cover glass 14CG and support structure 150. During manufacturing, display 14 may be formed by attaching display panel 14P to cover glass 14CG, backplate 48, and support structure 150. Compliant layer 50 may be used to couple cover glass 14CG to support structure 150. These display layers (e.g., cover glass 14CG, display panel 14P, backplate 48, support structure 150, compliant layer 50, etc.) may be placed in a molding tool (e.g., molding tool 120 of FIG. 14), and liquid adhesive 86 may be dispensed into the molding tool.

To ensure that the components of display panel 14P such as pixels P are not damaged during the molding process, adhesive 86 (e.g., a two-component polyurethane adhesive, a one-component light cured acrylic, or other suitable adhesive) may be a low viscosity adhesive that is able to flow through the mold at low pressure and at room temperature in a vacuum environment. When adhesive 86 has flowed throughout the molding tool to surround the periphery of display 14, adhesive 86 may directly contact cover glass 14CG, compliant layer 50, and support structure 150. As shown in FIG. 11, support structure 150 may include interlocking engagement features 100 (e.g., protrusions, recesses, etc.) that receive and/or protrude into adhesive 86 to form mechanical interlocks between adhesive 86 and support structure 150. If desired, adhesive 86 may hook over the top surface of cover glass 14CG, as shown in FIG. 11. While display 14 is in the molding tool with adhesive 86, heat and/or light may be applied to cure adhesive 86 to form display trim 12T. If desired, heat may be applied using an infrared light source, which heats adhesive 86 quickly without overheating display 14 (and without requiring that the entire display be placed in an oven for curing). Adhesive 86 that forms trim 12T may form an outermost exposed surface of device 10 and may be configured to withstand repeated handling and contact by a user, if desired.

FIG. 12 is a side view of device 10 showing how display trim 12T may be configured along long edges 96 in bend region 62. The side view of FIG. 12 is taken along line 52 and viewed in direction 54 of FIG. 2.

In bend region 62, backplate 48 and support structure 150 may be absent to provide display 14 with additional flexibility in bend region 62. Trim 12T in bend region 62 may be formed from adhesive 86F. Adhesive 86F may extend across bend axis 28 and may span across the gap between support structures 150 of FIG. 11. Adhesive 86F may be the same adhesive 86 that forms trim 12T in non-bending regions 60, or adhesive 86F may be a more compliant adhesive (e.g., an adhesive having a lower modulus of elasticity than adhesive 86 of non-bending regions 60) to provide additional flexibility in bend region 62. As shown in FIG. 12, adhesive 86F may hook over the top surface of cover glass 14CG and may hook under the lower surface of compliant layer 50, if desired.

In arrangements where adhesive 86F is the same adhesive that forms adhesive 86 of FIG. 11, this section of trim 12T may be formed during the same molding step that forms trim 12T in non-bending regions 60. In arrangements where adhesive 86F is a different type of adhesive than adhesive 86, this section of trim 12T may be formed during a separate molding step that occurs before or after molding trim 12T in non-bending regions 60. For example, using a molding tool with nested molds, a first shot of adhesive 86F may be injected and cured to form trim 12T in bend region 62, followed by a second shot of adhesive 86 that is injected and cured to form trim 12T in non-bending regions 60. If desired, trim 12T may be formed using more than two shots of polymer or adhesive. For example, a third shot of adhesive may form a thin outer layer over the first and second shots to hide any mismatching appearance between adhesive 86 in non-bending regions 60 and adhesive 86F in bend region 62. This is merely illustrative. If desired, a coating, film, or other outer layer may be used to hide any differences in appearance between the different adhesives that form trim 12T. Arrangements in which trim 12T is formed entirely from a single shot of adhesive 86 that extends continuously around the perimeter of display 14 are sometimes described herein as an example.

FIG. 13 is a side view of device 10 showing how display trim 12T may be configured along short edges 94 in non-bending regions 60. The side view of FIG. 13 is taken along line 40 and viewed in direction 42 of FIG. 2.

In non-bending regions 60, display 14 may be supported by backplate 48 and support structure 150. Support structure 150 may include upper surface 92 that supports edges 130 of display cover glass 14CG. Edges 130 of cover glass 14CG may extend beyond the edges of display panel 14P (e.g., edges 130 may be nonoverlapping with display panel 14P). Compliant layer 50 may be interposed between edges 130 of cover glass 14CG and upper surface 92 of support structure 150. Compliant layer 50 may provide a seal around display panel 14P and may support cover glass 14CG while allowing shear displacement between cover glass 14CG and display panel 14P.

A printed circuit such as flexible printed circuit 134 may be attached to an edge of display panel 14P. Flexible printed circuit 134 may bend behind display panel 14P and may be coupled to a main logic board, display driver circuitry, and/or other circuitry behind display panel 14P.

Trim 12T may be formed from adhesive such as adhesive 86 that is molded directly onto cover glass 14CG and support structure 150. In some arrangements, a single shot of adhesive 86 may be used to form the entirety of trim 12T (e.g., trim 12T of FIGS. 11, 12, and 13 may be formed from a single shot of adhesive 86). In other arrangements, adhesive 86 in non-bending regions 60 of FIGS. 11 and 13 may be a first type of adhesive, and adhesive 86F in bend region 62 may be a second type of adhesive (e.g., an adhesive that is more compliant than the adhesive in non-bending regions 60). For example, using a molding tool with nested molds, a first shot of adhesive 86F may be injected and cured to form trim 12T in bend region 62 (FIG. 12), followed by a second shot of adhesive 86 that is injected and cured to form trim 12T in non-bending regions 60 (FIGS. 11 and 13).

FIG. 14 is a diagram of an illustrative molding tool that may be used to mold display trim 12T directly onto display 14 as discussed in connection with FIGS. 2, 11, 12, and 13.

As shown in FIG. 14, molding tool 120 may include two or more molds such as first mold 108 (e.g., a lower mold) and second mold 106 (e.g., an upper mold). Molds 106 and 106 may be flexible ring-shaped molds that mate with each other at interface 110. Molds 106 and 108 may be formed from an elastomeric material such as silicone to enable molds 106 and 108 to be peeled away from display trim 12T after adhesive 86 is dispensed and cured in tool 120.

During molding operations, display 14 may be placed in molds 106 and 108. Lower mold 108 may form a seal on top surface 138 of cover glass 14CG. Upper mold 106 may form a seal on lower surface 140 of support structure 150. Molds 106 and 108 may define a recess such as channel 136 (e.g., a C-shaped channel, a U-shaped channel, an L-shaped channel, or a channel of other suitable shapes depending on the desired location and profile of trim 12T around display 14). Uncured liquid adhesive 86′ may be dispensed by dispenser 104 into channel 136 via inlet 142.

To ensure that the pixels and other circuitry of display panel 14P are not damaged during the molding process, adhesive 86′ may be a low viscosity adhesive that is able to flow through channel 136 at low pressure, at room temperature, and in a vacuum environment. When adhesive 86′ has flowed throughout channel 136, tool 112 may apply energy 114 to cure liquid adhesive 86′ to form cured adhesive 86 in channel 136. Tool 112 may be a heat source (e.g., an infrared heat source or other heat source), light source, or other energy source, and energy 114 may be heat, light (e.g., ultraviolet light), or other energy. In arrangements where adhesive 86′ is a two-component polyurethane adhesive, tool 112 may be a heat source that applies heat 114 to accelerate curing. In arrangements where adhesive 86′ is a one-component acrylic adhesive, tool 112 may be a light source that applies light 114 to cure adhesive 86′.

If desired, adhesive 86′ may be cured using tool 112 without placing display 14 in an oven. In particular, tool 112 may be an infrared light source that locally heats adhesive 86′ quickly without overly heating display 14 and without placing the entire mold and display into an oven. For example, the heat that is applied to cure adhesive 86′ in the molding tool may remain below 65 degrees Celsius to avoid damaging display 14 in molding tool 120, if desired.

After curing adhesive 86, molds 106 and 108 may be peeled away from display trim 12T. If desired, interface 110 may be located closer to the backside of display 14 (e.g., closer to support structure 150 than cover glass 14CG) to help reduce visibility of any parting line on trim 12T that is left by molding tool 120.

As shown in FIG. 14, display 14 includes first and second display portions that fold relative to one another along bend axis 28. A first support structure 150 may support the first display portion in a first non-bending region 60, and a second support structure 150 may support the second display portion in a second non-bending region 60. The first and second support structures 150 may be separated by a gap such as gap 152 in bend region 62 that overlaps bend axis 28. Adhesive 86 may extend along the entirety of long edges 96 and short edges 94 of device 10. In bend region 62, adhesive 86 may extend across bend axis 28 and may span across gap 152 between first and second support structures 150.

In arrangements where a single shot of adhesive forms the entirety of trim 12T, adhesive 86 that spans across gap 152 in bend region 62 may be formed from the same material and during the same molding step that forms adhesive 86 in non-bending regions 60. In arrangements where multiple shots of plastic are used to form trim 12T, a first shot of adhesive (e.g., adhesive 86F of FIG. 12) may be injected and cured to form trim 12T in gap 152 of bend region 62, and a second shot of adhesive (e.g., adhesive 86 of FIGS. 11 and 13) may be injected and cured to form trim 12T in non-bending regions 60. With this type or arrangement, molding tool 120 may include more than two molds to allow trim 12T to be formed from multiple shots of adhesive. The molds may include three or more nesting molds (e.g., flexible elastomeric rings) with interlocking engagement features between molds to ensure that the different shots of adhesive have mechanical interlocks with each other.

Device 10 may be operated in a system that uses personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. An electronic device, comprising:
a flexible display configured to fold along a bend axis; and
a display trim surrounding the flexible display, wherein the display trim comprises:
first and second metal support structures each having an upper surface configured to support the flexible display, wherein the first and second metal support structures are separated by a gap that overlaps the bend axis;
a first polymer overmolded onto the first and second metal support structures; and
a second polymer that spans the gap between the first and second metal support structures, wherein the second polymer has a lower modulus of elasticity than the first polymer.

2. The electronic device defined in claim 1 wherein the display trim further comprises:
third and fourth metal support structures each having an additional upper surface configured to support the flexible display, wherein the third and fourth metal support structures are separated by an additional gap that overlaps the bend axis.

3. The electronic device defined in claim 2 wherein the second polymer spans the additional gap between the third and fourth metal support structures.

4. The electronic device defined in claim 3 wherein the gap and the additional gap are located on respective first and second opposing sides of the flexible display.

5. The electronic device defined in claim 4 wherein the flexible display has third and fourth opposing sides that are orthogonal to the first and second opposing sides, wherein the first polymer has a first break on the third side and a second break on the fourth side, and wherein the second polymer spans across the first and second breaks in the first polymer.

6. The electronic device defined in claim 2 wherein the first, second, third, and fourth metal support structures each comprise an L-shaped member that supports a respective corner of the flexible display.

7. The electronic device defined in claim 1 wherein the second polymer comprises an elastomeric polymer.

8. The electronic device defined in claim 1 further comprising a compliant layer interposed between the upper surface and the flexible display.

9. The electronic device defined in claim 1 wherein first polymer has a lip that hooks over a top surface of the flexible display and wherein the flexible display is configured to slide within an air gap between the lip and the upper surface.

10. The electronic device defined in claim 1 further comprising a rear housing wall, wherein the first and second metal support structures are interposed between the flexible display and the rear housing wall and wherein the first and second metal support structures are configured to shear relative to the rear housing wall.

11. An electronic device, comprising:
a foldable display having first and second portions that fold relative to one another along a bend axis;
a display trim that wraps around a periphery of the foldable display, wherein the display trim comprises a metal portion and a plastic portion overmolded onto the metal portion, and wherein an edge of the foldable display is sandwiched between the plastic portion and the metal portion; and
a rear housing wall, wherein the metal portion is configured to shear relative to the rear housing wall as the foldable display is folded and unfolded.

12. The electronic device defined in claim 11 wherein the plastic portion comprises a first polymer having a first elastic modulus and a second polymer having a second elastic modulus that is lower than the first elastic modulus.

13. The electronic device defined in claim 12 wherein the first polymer wraps around respective corners of the foldable display and the second polymer overlaps the bend axis.

14. The electronic device defined in claim 13 wherein the second polymer spans across first, second, third, and fourth gaps in the first polymer.

15. The electronic device defined in claim 14 wherein the first, second, third, and fourth gaps are located respectively on first, second, third, and fourth sides of the foldable display.

16. An electronic device, comprising:
a display configured to fold along a bend axis, wherein the display comprises a pixel array and a cover glass overlapping the pixel array; and
a display trim that wraps around the display, wherein the display trim comprises an adhesive that is molded onto a peripheral edge of the cover glass.

17. The electronic device defined in claim 16 wherein the display further comprises:
first and second display portions that fold relative to one another along the bend axis; and
first and second support structures respectively overlapping the first and second display portions, wherein the first and second support structures are separated by a gap that overlaps the bend axis and wherein the display trim extends across the gap.

18. The electronic device defined in claim 17 wherein the first and second support structures include interlocking engagement features that interlock with the adhesive.

19. The electronic device defined in claim 17 wherein each of the first and second support structures has an upper surface that supports the cover glass, the electronic device further comprising a compliant layer coupled between the peripheral edge of the cover glass and the upper surface.

20. The electronic device defined in claim 16 wherein the adhesive forms an outer exposed surface of the electronic device and is selected from the group consisting of: a two-component polyurethane adhesive and a one-component acrylic adhesive.
